(19) United States
(12) Patent Application Publication
(10) Pub. No.: US 2007/0061137 A1
(43) Pub. Date: Mar. 15, 2007

(54) Method for recovering frame erasure at voice over internet protocol (VoIP) environment

(76) Inventors: Hae Yong Yang, Daejeon (KR); Jeong Seok Lim, Daejeon (KR); Kyung Hoon Lee, Daejeon (KR); Sang Kyung Yoo, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/304,278

(22) Filed: Dec. 15, 2005

(30) Foreign Application Priority Data
Sep. 9, 2005 (KR) 2005-84256

(51) Int. Cl. G10L 19/12

(52) U.S. Cl. 704/222

(57) ABSTRACT

A method for recovering a frame erasure at a voice over internet protocol (VoIP) environment is provided. The method includes: extracting coder parameters of received packets; if an erased packet exists during the extracting of the coder parameters, regenerating speech characteristic parameters of the erased packet by referencing a vector quantization codebook index interpolation table (VCIIT) formulated based on representative values of speech characteristic parameters reflecting auditory recognition characteristics and performing a linear interpolation on speech characteristic parameters of the normally received packets allocated previous and future of the erased packet; and recovering the erased packet by combining the regenerated speech characteristic parameters. The proposed frame erasure recovery method can minimize an additional delay and increases in bandwidth and computation and improve a capability of recovering the erasure. Also, the frame erasure recovery method can be easily implemented to a VoIP system.

### BACKGROUND OF THE INVENTION

1. Field of the Invention

The present invention relates to a method for recovering a frame erasure at a voice over internet protocol (VoIP) environment, and more particularly, to a method for recovering a frame erasure at a VoIP environment utilizing a code excited linear predictive coding (CELP)-based coder, wherein the method can minimize a degradation of speech quality caused by an erasure of a speech frame through employing a receiver based erasure recovery method.

2. Description of the Related Art

Determination of a packet erasure at a voice over internet protocol (VoIP) communications environment can vary depending on a VoIP system. Thus, a specific determination method is not described herein, and it is assumed that an implemented VoIP system determines the packet erasure and outputs the determination result.

Because of several advantages such as a flexible network management of a convergence network and a reduced cost related to communications, the VoIP has been rapidly and widely commercialized. It has been even expected that the VoIP will replace conventional telecommunications services eventually in near future. However, the VoIP communications environment inevitably has several disadvantageous factors that cause a deterioration of communications quality due to a characteristic of a data network providing the best effort service. Examples of such factors are an erasure, a delay and a jitter. Various methods have been suggested to overcome the deterioration of communications quality. Currently, sender/receiver based erasure recovery methods have been employed as the most practical method for overcoming the above limitation.

As described in an article by Hardman et al., entitled “Reliable Audio for Use over the Internet, Proceedings on INET'95, 1995, a media-specific forward error correction (FEC) method, which is one of the sender based erasure recovery methods, utilizes a primary coder and a secondary coder and adds a packet of the secondary coder to a future packet of the primary coder for the recovery purpose. More specifically, when a packet erasure arises, the packet of the secondary coder which is normally transferred from the previous frame is used to recover the packet erasure. However, this method has disadvantages. Since two packets, which are outputs of the primary coder and the secondary coder, need to be transferred simultaneously, a bandwidth increases. Also, a frame delay event occurs to be ready for a possibility of using the secondary coder when an erasure is generated. It is generally required to implement two coders at a sending terminal and a receiving terminal and thus, an amount of computation and a difficulty of implementing the required coders increase.

In a single side repetition method, which is one representative receiver based erasure recovery method, a G.723.1 coder (i.e., a dual rate speech coder for multimedia communications transmitting at 5.3 kbit/s and 6.3 kbit/s) which was introduced and recommended by the international telecommunications union-telecommunication standardization (ITU-T) sector in 1996 will be described as an example to describe operation and limitations related to the single side repetition method. Particularly, the G.723.1 coder has been widely used in the VoIP field. The ITU-T G.723.1 coder is a narrow-band codec classified into a CELP group and is configured with two data channels of 5.3 kbps and 6.3 kbps. The two coders include coefficients of a line spectral pair (LSP), an adaptive codebook and a fixed codebook and are the same in the exception that an algorithm for generating the fixed codebook is separated. As illustrated in FIG. 1, the G.723.1 coder is provided with an intrinsic function of the single side repetition method to be ready for an erasure incidence. When one frame is erased, the G.723.1 coder operates as a recovery unit. With reference to FIG. 1, this operation will be described in detail hereinafter.

FIG. 1 is a diagram illustrating the configuration of the conventional G.723.1 coder for the receiver based erasure recovery method and showing how the conventional G.723.1 coder operates.

For the receiver based erasure recovery, the G.723.1 coder includes: a LSP estimation unit 100; a voiced/unvoiced sound decision unit, a periodic excitation signal generation unit 120; a random signal generation unit 130; a gain estimation unit 140; and a LP synthesis unit 150. The LSP estimation unit 100 estimates LSP coefficients of an erased frame using normally received LSP coefficients of a previous frame. The voiced/unvoiced sound decision unit 110 decides whether the erased frame includes a voiced sound or a unvoiced sound using a normally received speech signal of the previous frame. As for the voiced sound, the periodic excitation signal generation unit 120 generates a periodic signal using a normally received residual signal of the previous frame. As for the unvoiced sound, the random signal generation unit 130 generates a random signal using a seed. The gain estimation unit 140 lowers an output level to decrease gains with respect to the voiced sound and the unvoiced sound. The LP synthesis unit 150 estimates a speech signal of the erased frame using an output from the LSP estimation unit 100 and the outputted excitation signal whose level is decreased by the gain estimation unit 140.

A conventional receiver based erasure recovery method using the G.723.1 coder (hereinafter “G.723.1 receiver based erasure recovery method”) will be explained hereinafter.

The LSP estimation unit 100 estimates LSP coefficients of an erased frame ng a normally received LSP coefficient of a previous frame and transmits the estimation result to the LP synthesis unit 150. Using a normally received speech signal of the previous frame, the voiced/unvoiced sound decision unit 110 decides detects whether the erased frame includes a voiced sound or a unvoiced sound. In the case of the voiced sound, a normally received residual signal of the previous frame is passed through the periodic excitation signal generation unit 120 to generate a periodic signal. In the case of the unvoiced sound, the random signal generation unit 130 outputs a random signal using a random seed. The gain estimation unit 140 decreases gains of the periodic signal and the random signal to lower an overall output level, which is subsequently transmitted to the LP synthesis unit 150. The LP synthesis unit 150 estimates a speech signal of the erased frame using the output from the LSP estimation unit 100 and the excitation signal whose level is decreased by the gain estimation unit 140.

FIGS. 2A to 2E show waveform diagrams exhibiting performance analysis results on the conventional G.723.1 receiver based erasure recovery method at no erasure environment and at 10% erasure environment.

Particularly, FIGS. 2A to 2E illustrate waveform diagrams comparing several distortion parameters extracted for the performance analysis on the conventional G.723.1 receiver based erasure recovery method. FIG. 2A represents a waveform of an output from the G.723.1 coder at the environment without any erasure. FIG. 2B represents a waveform of an output from the G.723.1 at the above mentioned erasure environment and also shows a location of the erasure colored in gray. FIG. 2C is a spectral distortion contour at the environment without any erasure colored in black and at the above mentioned erasure environment colored in gray. FIG. 2D is an energy contour at the environment without any erasure colored in black and at the above mentioned erasure environment colored in gray. FIG. 2E is a pitch contour at the environment without any erasure colored in black and at the above mentioned erasure environment colored in gray.

As illustrated in the spectral distortion contour in FIG. 2C and in the energy contour illustrated in FIG. 2D, lots of distortion are generated at parameters of time and frequency due to a single frame erasure. In addition to the frame where the erasure event occurs, the distortion is propagated to several other following frames. When the erasure event occurs, as illustrated in FIG. 2E, a period of a pitch of a previous frame is simply repeated. Based on the above performance analysis results illustrated in FIGS. 2A to 2E, when the single side repetition method is used in the CELP-based coder, even a slight erasure generated at the VoIP environment may deteriorate a quality of erasure recovery.

The conventional sender based erasure recovery method generally has disadvantages such as an additional delay, an increased bandwidth and a burden on computation. On the other hand, the conventional receiver based erasure recovery method often has a limitation in recovery performance.

### SUMMARY OF THE INVENTION

Accordingly, the present invention is directed to a method for recovering a frame erasure at a voice over internet protocol (VoIP) environment, which substantially obviates one or more problems due to limitations and disadvantages of the related art.

It is an object of the present invention to provide a method for recovering a frame erasure at a VoIP environment with an improved speech quality through generating a vector quantization (VQ) codebook index interpolation table (VCIIT) and recovering an erased packet based on an erased VQ codebook index through simply referencing the VCIIT with using VQ codebook indices of normally received packets allocated at both ends of the erased packet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for recovering a frame erasure at a VoIP (voice over internet protocol) environment, including the steps of: extracting coder parameters of received packets; if an erased packet exists during the extracting of the coder parameters, regenerating speech characteristic parameters of the erased packet by referencing a vector quantization codebook index interpolation table (VCIIT) formulated based on representative values of speech characteristic parameters reflecting auditory recognition characteristics and performing a linear interpolation on speech characteristic parameters of the normally received packets allocated previous and future of the erased packet; and recovering the erased packet by combining the regenerated speech characteristic parameters.

The step of regenerating the speech characteristic parameters includes the steps of: generating a LSP parameter by simply referencing line spectral pair (LSP) VCIIT using normally received coefficients of the previous and future frame; generating an adaptive codebook lag parameter through performing a linear interpolation on the normally received packets; generating an adaptive codebook gain parameter simply referencing adaptive codebook gain VCIIT using normally received coefficient of the previous and future frame; performing a linear interpolation on the normally received packets to generate a fixed codebook gain parameter; and generating the rest parameters using parameters of the normally received packet ahead of the erased packet.

The VCIIT for generating the LSP parameter is formulated as follows:
E_{k,i,j}=(r_{i,j}−\tilde{e}ₖ)W_{i,j}(r_{i,j}−\tilde{e}ₖ)^{r} Eq. 1
where \tilde{e}ₖ, r_{i,j} and W_{i,j} represent content of the ith row and the jth column in the VCIIT, a linearly interpolated parameter of corresponding LSP coefficients and a parameter reflecting auditory characteristics of human beings.

The VCIIT for generating the adaptive codebook gain parameter is formulated according to the following equation:

$${gE}_{k , i , j} = {{\sum }_{1}}^{5} [ {( g {r}_{i , j} )}^{T} ( g {r}_{i , j} ) - {( {gp}_{k} )}^{T} ( {gp}_{k} ) ] \qquad Eq . 2$$

where g and r_{i,j} represent a gain coefficient and a linearly interpolated parameter of a corresponding gain coefficient.

After the step of recovering the erased packet, the method further includes the steps of: converting the recovered packet into a digital speech signal at a decoder; and generating an analog speech signal at a digital-to-analog converter and outputting the analog speech signal.

The coder is selected from a group consisting of a linear predictive coding (LPC) extracting and coding a specific parameter using a speech signal vocalization model, a source coding including a multi-pulse, multi-level quantization (MP-MLQ), a code excited linear predictive coding (CELP) obtained by combining a waveform coding and a source coding, a sub-band coding (SBC), an adaptive predictive coding (APC), an adaptive transform coding (ATC), a residual excited linear predictive coding (RELP), and a hybrid coding including a multi-pulse linear predictive coding (MPLPC).

The frame erasure recovery method including the aforementioned sequential steps from the extracting of the coder parameters to the recovering of the erased packet is performed at an erased packet recovery unit of a microprocessor block storing the VCIIT.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a diagram illustrating the configuration of a G.723.1 coder for a conventional receiver based erasure recovery method and how the G.723.1 coder operates according to the conventional receiver based erasure recovery method;

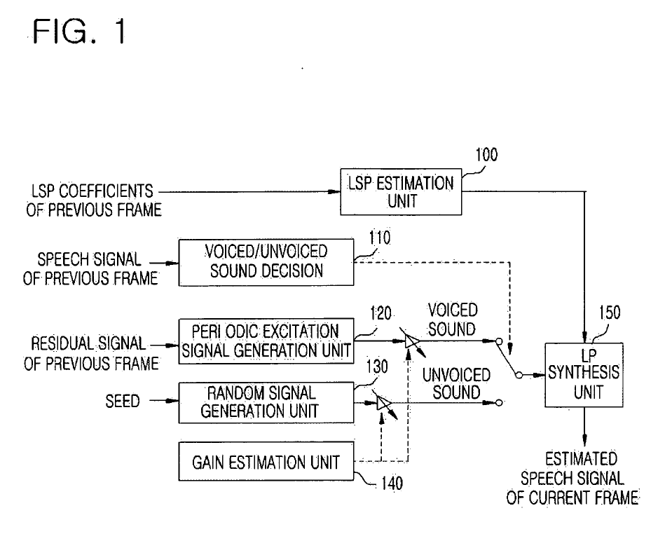

FIGS. 2A to 2E are waveform diagrams illustrating performance analysis results on the conventional receiver based erasure recovery method using the G.723.1 coder at no erasure environment and at 10% erasure environment;

FIGS. 3A to 3C illustrate output waveform spectrograms at different environments defined according to a line spectral pair (LSP) vector quantization codebook index table (VCIIT) implemented according to an exemplary embodiment of the present invention;

FIG. 4 is a diagram illustrating the configuration for a vector quantization (VQ) codebook index interpolation method according to the exemplary embodiment of the present invention

FIG. 5 is a flowchart illustrating sequential operations for the VQ codebook index interpolation method according to the exemplary embodiment of the present invention;

FIGS. 6A to 6F are waveform diagrams illustrating performance analysis results on the VQ codebook index interpolation method at no erasure environment and at approximately 10% erasure environment according to the exemplary embodiment of the present invention; and

FIG. 7 is a graph illustrating an analysis result on the VQ codebook index interpolation method according to the exemplary embodiment of the present invention

### DETAILED DESCRIPTION OF THE INVENTION

Reference will now be made in detail to the preferred embodiments of the present invention, examples of which are illustrated in the accompanying drawings.

According to an exemplary embodiment of the present invention, a method for recovering a frame erasure at a voice over intemet protocol (VoIP) communications code excited linear predictive coding (CELP) environment utilizes a vector quantization (VQ) codebook index interpolation method.

It is necessary to generate a VQ codebook index interpolation table (VCIIT) to perform the erasure recovery method. A G.723.1 coder is used as an exemplary coder for the above method. The G.723.1 coder uses VQ for gains of a line spectral pair (LSP) and an adaptive codebook. Hereinafter, the VCIIT generation will be described in detail.

The LSP VQ uses a split VQ in the form of approximately 3, approximately 3, approximately 4 sub-vectors, each including approximately 256 elements, and each vector can be expressed as the following equation.

$${\tilde{e}}_{l , m} = [ \begin{matrix}{\tilde{e}}_{1 , l , m} & {\tilde{e}}_{2 , l , m} & ⋯ & {\tilde{e}}_{K , l , m}\end{matrix} ] , \\ \begin{matrix}0 \leq m \leq 2 \\ 1 \leq l \leq 256\end{matrix} , \\ K = \{ \begin{matrix}3 , m = 0 \\ 3 , m = 1 \\ 4 , m = 2\end{matrix} \qquad Eq . 1$$

Herein, \tilde{e}_{l,m} is an element of the lth order in a VQ table of the mth sub-vector. For better understanding of the VCIIT generation, it is assumed the case of m=2.

To generate content of the VCIIT in the jth row and the jth column, an operation of searching ‘k’, which minimizes an error reference value of E_{k,i,j} defined by the fourth equation below, among approximately 256×256 case numbers is instigated. The extracted \tilde{e}ₖ becomes the content in the jth row and the jth column of the VCIIT.

$$\begin{matrix}{\tilde{e}}_{i} = [ \begin{matrix}{\tilde{e}}_{1 , i} & {\tilde{e}}_{2 , j} & {\tilde{e}}_{3 , i} & {\tilde{e}}_{4 , j}\end{matrix} ] , \\ 1 \leq i \leq 256 & Eq . 2 \\ {r}_{i , j} = ( \frac{{\tilde{e}}_{i} + {\tilde{e}}_{j}}{2} ) , \\ I \leq i , j \leq 256 & Eq . 3 \\ {E}_{k , i , j} = ( {r}_{i , j} - {\tilde{e}}_{k} ) {{W}_{i , j} ( {r}_{i , j} - {\tilde{e}}_{k} )}^{T} , \\ 1 \leq i , j , k \leq 256 & Eq . 4\end{matrix}$$

Herein, r_{i,j} represents a linearly interpolated parameter of corresponding LSP coefficients. W_{i,j} is a weight factor and is a parameter reflecting human's auditory characteristic. When r_{q,i,j}−r_{(q-1),i,j} is large, it is considered an important parameter, and thus, W_{i,j} is used to give high weight to this parameter. The same operation is performed for the cases of m=0 and m=1.

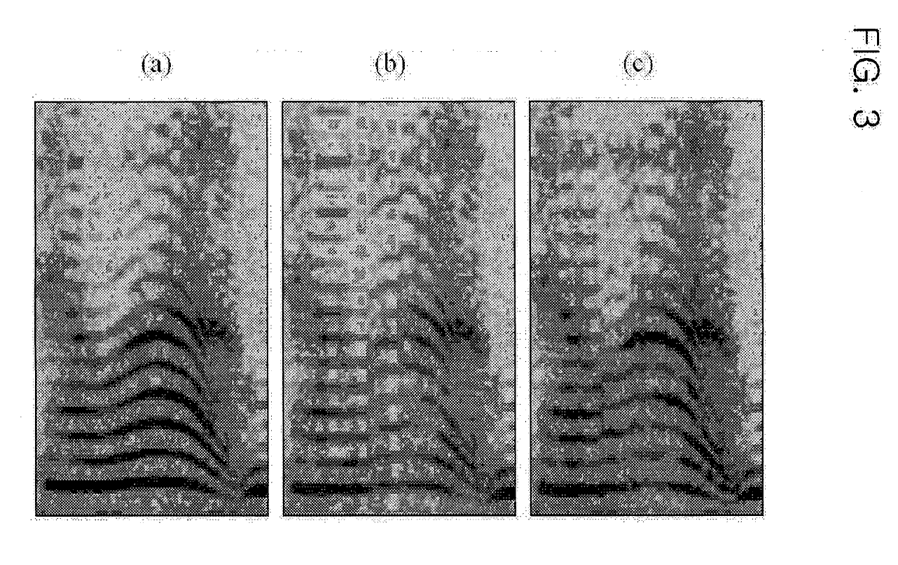

FIGS. 3A to 3C illustrate output waveform spectrograms at different environments defined according to the LSP VCIIT implemented according to the exemplary embodiment of the present invention.

Particularly, FIG. 3A is a spectrogram of an output waveform of a coder at the environment without any erasure. FIG. 3B is a spectrogram of an output waveform of the coder at the environment defined by the conventional method. FIG. 3C is a spectrogram of an output waveform of the coder at the environment with an erasure defined by the exemplary embodiment of the present invention. As mentioned above, the coder is the G.723.1 coder.

In more detail, compared with the spectrogram illustrated in FIG. 3B, the spectrogram illustrated in FIG. 3C is recovered as close as the spectrogram obtained at the environment without any erasure as illustrated in FIG. 3A.

The adaptive codebook gain is configured via VQ of a 20 dimensional vector including approximately 85 components or 170 components. The decoder uses the first five vectors of each VQ defined as the following equations to find the optimum index. The equations are defined as follows.

$$\begin{matrix}{gp}_{i} = [ \begin{matrix}{gp}_{1 , i} & {gp}_{2 , i} & {gp}_{3 , i} & {gp}_{4 , i} & {gp}_{5 , i}\end{matrix} ] , \\ 1 \leq i \leq 170 & Eq . 5 \\ {gr}_{i , j} = ( \frac{{gp}_{i} + {gp}_{j}}{2} ) , \\ 1 \leq i , j \leq 170 & Eq . 6 \\ {gE}_{k , i , j} = {{\sum }_{1}}^{5} [ {( g {r}_{i , j} )}^{T} ( g {r}_{i , j} ) - {( {gp}_{k} )}^{T} ( {gp}_{k} ) ] , \\ 1 \leq i , j \leq 170 & Eq . 7\end{matrix}$$

Herein, being different from the method using the LSP coefficient, this method uses a partial number of the vectors (i.e., the first five vectors) instead of using the entire vectors and does not include an additional weight factor. The above equations correspond to VQ of approximately 170 components, and the same extraction method is performed for VQ of approximately 85 components.

As described above, the LSP VCIIT includes three matrixes each of approximately 256×256. On the other hand, the adaptive codebook gain VCIIT includes two matrixes: one of approximately 170×170 and the other of approximately 85×85. Considering that each of the above VCIITs is symmetric, the total storage capacitance required to store the entire VCIIT is approximately 116 Kbytes.

Hereinafter, detailed description of the exemplary frame erasure recovery method at the CELP-based VoIP communications environment using the VCIIT generated as above will be provided.

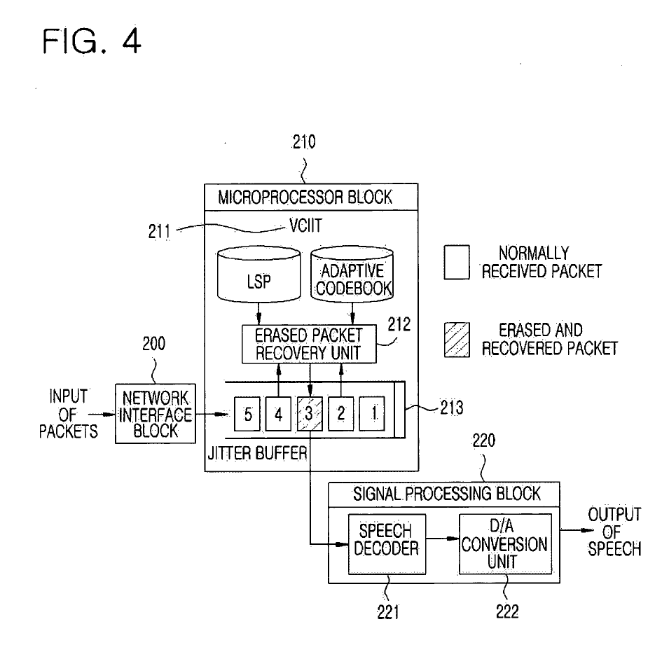

FIG. 4 is a diagram illustrating the configuration for the VQ codebook index interpolation method according to the exemplary embodiment of the present invention.

As illustrated, a network interface block 200, a microprocessor block 210 and a signal processing block 220 are used to recover a frame erasure at the CELP-based VoIP communications environment. The network interface block 200 is responsible for inputting VoIP packets. The microprocessor block 210 stores the VoIP packets and restores an erased packet. The signal processing block 220 decodes a speech packet.

The microprocessor block 210 includes: a VCIIT 211 previously calculated and stored; an erased packet recovery unit 212 recovering an erased packet; a jitter buffer 213 correcting an erasure caused by a jitter event.

The signal processing block 220 includes: a speech decoder 221 decoding a compressed speech packet; and a digital-to-analog (D/A) conversion unit 222 converting a digital signal into an analog signal.

The erased packet can be easily recovered by using the previously prepared VCHT 211 at the microprocessor block 210.

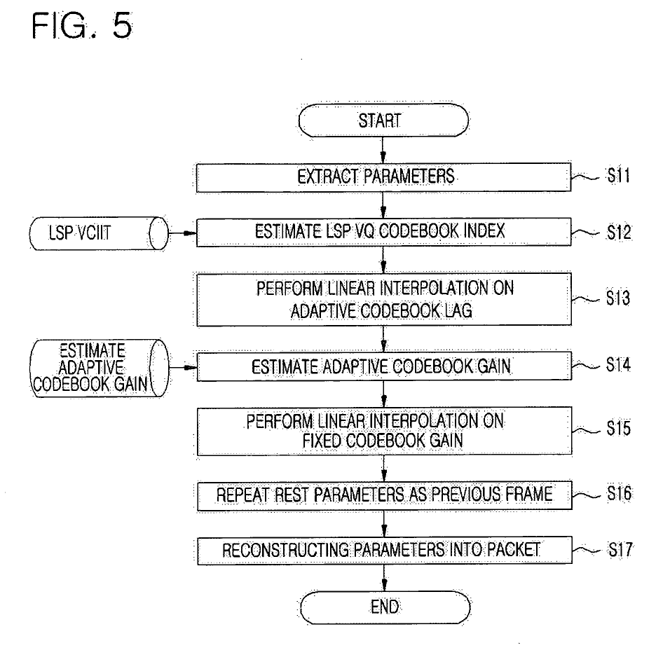

More specifically, VoIP packets are inputted to the jitter buffer 213 of the microprocessor block 210 through the network interface unit 200. The jitter buffer 213 is employed to minimize a degradation of communications quality caused by jitters which may be generated during the network transfer. Generally, the jitter buffer 213 has a length of approximately 30 milli-seconds to approximately 50 milli-seconds. If the third packet is erased, the erased packet recovery unit 212 uses the second packet and the fourth packet, which are normally received, to recover the erased third packet according to sequential operations described in FIG. 5. The recovered packet is then transferred to the signal processing block 220. The speech decoder 221 coverts the transferred packet into a digital speech signal and then, the D/A conversion unit 222 converts the digital speech signal into an analog speech signal.

FIG. 5 is a flowchart illustrating sequential operations for the VQ codebook index interpolation method according to the exemplary embodiment of the present invention.

The VQ codebook index interpolation method includes: extracting parameters of normally received packets (S11); estimating a LSP VQ codebook index (S12); estimating a lag of the adaptive codebook (S13); estimating a gain of the adaptive codebook (S14); estimating a gain of a fixed codebook (S15); repeating the rest parameters (S16); and reconstructing the estimated parameters into a packet (S17).

In operation of S11, parameters of the second packet and the fourth packet of the G.723.1 coder are extracted. In operation of S12, LSP VQ codebook indices of the both end packets (i.e., the second packet and the fourth packet) are assumed as inputs of the LSP VCIIT, and the contents of the corresponding addresses are read to estimate a LSP VQ codebook index of the erased packet. Since the adaptive codebook lag parameter is an integer, in operation of S13, the parameter of the erased packet is estimated through performing a liner interpolation on the parameters of the both end packets. In operation of S14, an adaptive codebook gain index of the erased packet is estimated by assuming the adaptive codebook gain indices of the both end packets as inputs of the adaptive codebook gain VCIIT and reading the contents of the corresponding addresses. Since the fixed codebook gain is quantized in scalar in the logarithmic scale, in operation of S15, the indices of the both end packets is estimated through the linear interpolation method. In operation of S16, the reset parameters for generating the fixed codebook are obtained by repeating the parameters of the second packet which is normally received ahead of the third packet (i.e., the erased packet). In operation of S17, the erased packet is recovered using the estimated parameters.

Herein, the index estimation means an LSP parameter generation or an adaptive codebook gain parameter generation. For instance, the LSP parameter is generated through sequential operations of: searching. a LSP index of a crossing point at which LSPs of the both end packets commonly meet (hereinafter “LSP crossing point index”) from the VCIIT formulated in matrix tables of each LSP of the normally received both end packets; and corresponding the LSP crossing point index to the representative crossing point index. The adaptive codebook gain parameter is generated through sequential operations of: searching an index of a crossing point at which gains of the both end packets commonly meet (hereinafter “gain crossing point index”); and corresponding the gain crossing point index to the above gain crossing point index.

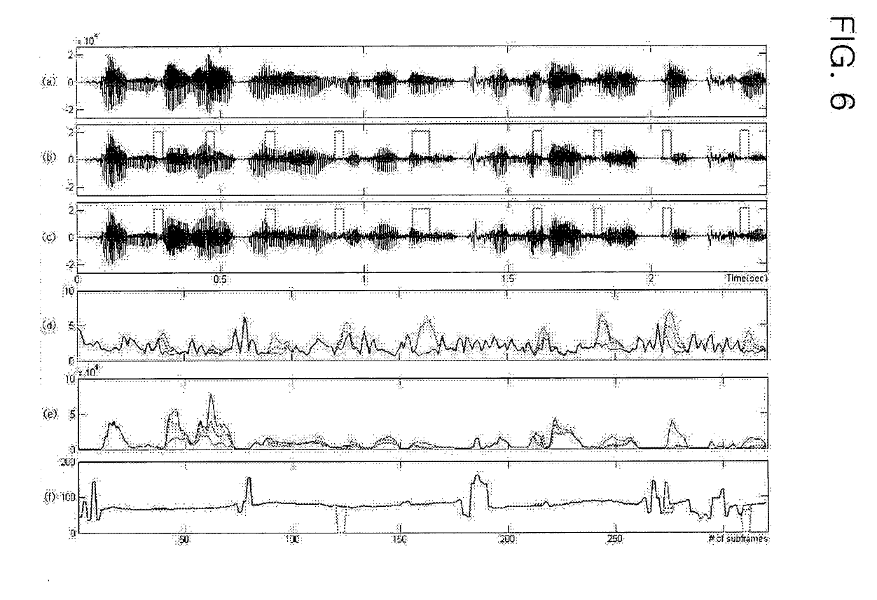

FIGS. 6A to 6F are waveform diagrams illustrating performance analysis results on the VQ codebook index interpolation method at no erasure environment and at approximately 10% erasure environment according to the exemplary embodiment of the present invention.

Particularly, FIG. 6A illustrates a waveform of an output of the coder at the environment without any erasure. FIG. 6B illustrates a waveform of an output of the coder at the conventional erasure environment and a location of the erasure colored in gray. FIG. 6C illustrates a waveform of an output of the coder at the erasure environment defined according to the exemplary embodiment and a location of the erasure colored in gray. FIG. 6D is a spectral distortion contour at the environment without any erasure colored in black, at the conventional erasure environment colored in gray and at the erasure environment defined according to the embodiment of the present invention exhibited in a dotted line. FIG. 6E is an energy contour at the environment without any erasure colored in black, at the conventional erasure environment colored in gray and at the erasure environment defined according to the embodiment of the present invention exhibited in a dotted line. FIG. 6F is a pitch contour at the environment without any erasure colored in black, at the conventional erasure environment colored in gray and at the erasure environment defined according to the embodiment of the present invention exhibited in a dotted line.

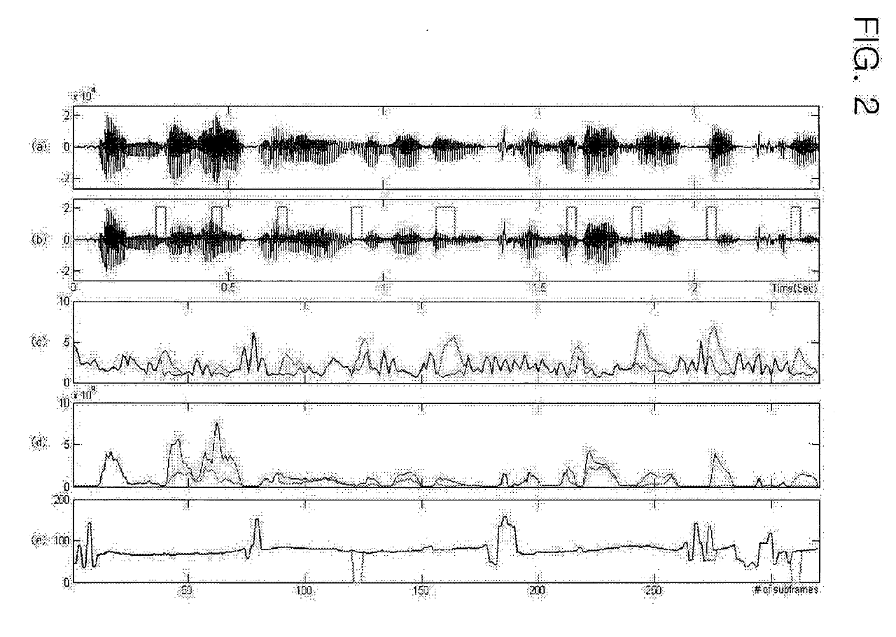

In comparison with FIGS. 2A to 2E, the spectral distortion contour illustrated in FIG. 6D, the energy contour illustrated in FIG. 6E and the pitch contour illustrated in FIG. 6F indicate that the distortion is decreased at parameters of time and frequency.

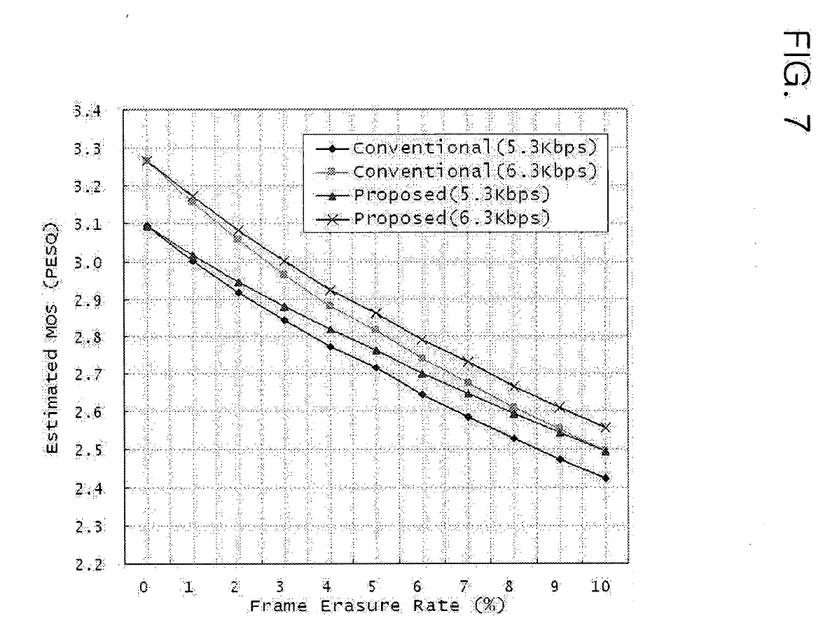

FIG. 7 is a graph illustrating an analysis result on the VQ codebook index interpolation method according to the exemplary embodiment of the present invention. Particularly, FIG. 7 is a graph showing a relationship between a frame erasure rate and an estimated mean opinion score.

The test was performed to obtain statistical data by repeating a perceptual evaluation of speech quality (PESQ) algorithm approximately 100 times with the application of a speech database of approximately 50 male/female speakers using the secondary Gilbert model for a network environment modeling.

As the frame erasure rate increases, the conventional method exhibits a degraded speech quality of the two coders. However, according to the exemplary embodiment of the present invention, the two coders exhibit a gradual speech quality degradation contour, and at approximately 10% erasure environment, the speech quality of the coder with 5.3 Kbps according to the exemplary embodiment of the present invention is similar to that of the conventional coder with 6.3 Kbps.

According to the exemplary embodiment of the present invention, approximately 116 Kbytes of memory storage capacitance is required for the microprocessor block configuring the VolP system, and operations of referencing certain memory storage capacitance and performing a linear interpolation of several parameters are additionally performed to recover the erased packet. The aforementioned memory storage capacitance of approximately 116 Kbytes is not a great burden to the microprocessor block with several megabytes of memory storage capacitance and also, the above additional operations for recovering the erased packet can be negligible. Since the erasure recovery method according to the exemplary embodiment of the present invention is a receiver based one, there is no increase in the bandwidth. Without modifying a speech coder of a sender/receiver, certain operations are simply added to the microprocessor block, the frame erasure recovery method can be easily implemented to the VoIP system.

On the basis of the exemplary embodiment of the present invention, the frame erasure recovery method at the VoIP environment can minimize an additional delay and increase in a bandwidth and a computation burden and improve an erasure recovery function to a sufficient extent through a simple referencing operation using a precedently formulated VCIIT. As a result, the improvement on the erasure recovery function can be achieved without an additional burden and the above proposed recovery method can be easily implemented to the VoIP system.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for recovering a frame erasure at a VoIP (voice over internet protocol) environment, comprising the steps of:
extracting coder parameters of received packets;
if an erased packet exists during the extracting of the coder parameters, regenerating speech characteristic parameters of the erased packet by referencing a vector quantization codebook index interpolation table (VCIIT) formulated based on representative values of speech characteristic parameters reflecting auditory recognition characteristics and performing a linear interpolation on speech characteristic parameters of the normally received packets allocated previous and future of the erased packet; and
recovering the erased packet by combining the regenerated speech characteristic parameters.

2. The method of claim 1, wherein the step of regenerating the speech characteristic parameters includes the steps of:
generating a LSP parameter by simply referring line spectral pair (LSP) VCIIT using normally received coefficients of the previous and future frame
generating an adaptive codebook lag parameter through performing a linear interpolation on the normally received packets;
generating an adaptive codebook gain parameter simply referring adaptive codebook gain VCIIT using normally received coefficients of the previous and future frame;
performing a linear interpolation on the normally received packets to generate a fixed codebook gain parameter; and
generating the rest parameters using parameters of the normally received packet ahead of the erased packet.

3. The method of claim 1, wherein the VCIIT for generating the LSP parameter is formulated as follows:
E_{k,i,j}=(r_{i,j}−\tilde{e}ₖ)W_{i,j}(r_{i,j}−\tilde{e}ₖ)^{r} Eq. 1
where \tilde{e}ₖ, r_{i,j} and W_{i,j} represent content of the ith row and the jth column in the VCIIT, a linearly interpolated parameter of corresponding LSP coefficients and a parameter reflecting auditory characteristics of human beings.

4. The method of claim 3, wherein the parameter of W_{i,j} is applied when a value of r_{q,i,j}−r_{(q-1),i,j} is large.

5. The method of claim 3, wherein the vector quantization of the LSP utilizes a split vector quantization in the form of sub-vectors of sizes approximately 3, approximately 3 and approximately 4, each with approximately 256 elements and each vector is defined as follows:
$${\tilde{e}}_{l , m} = [ \begin{matrix}{\tilde{e}}_{1 , l , m} & {\tilde{e}}_{2 , l , m} & ⋯ & {\tilde{e}}_{K , l , m}\end{matrix} ] , \\ \begin{matrix}0 \leq m \leq 2 \\ 1 \leq l \leq 256\end{matrix} , \\ K = \{ \begin{matrix}3 , m = 0 \\ 3 , m = 1 \\ 4 , m = 2\end{matrix} \qquad Eq . 2$$
where \tilde{e}_{l,m} is the lth element of the VCIIT of the mth sub-vector.

6. The method of claim 2, wherein the VCIIT for generating the adaptive codebook gain parameter is formulated according to the following equation:
$${gE}_{k , i , j} = {{\sum }_{1}}^{5} [ {( g {r}_{i , j} )}^{T} ( g {r}_{i , j} ) - {( {gp}_{k} )}^{T} ( {gp}_{k} ) ] \qquad Eq . 3$$
where g and r_{i,j} represent a gain coefficient and a linearly interpolated parameter of a corresponding gain coefficient.

7. The method of claim 6, wherein the adaptive codebook gain is configured with vector quantization of a 20-dimensional vector including one of approximately 85 components and approximately 170 components.

8. The method of claim 1, after the step of recovering the erased packet, further including the steps of:
converting the recovered packet into a digital speech signal at a decoder; and
generating an analog speech signal at a digital-to-analog converter and outputting the analog speech signal.

9. The method of claim 1, wherein the coder is selected from a group consisting of a linear predictive coding (LPC) extracting and coding a specific parameter using a speech signal vocalization model, a source coding including a multi-pulse, multi-level quantization (MP-MLQ), a code excited linear predictive coding (CELP) obtained by combining a waveform coding and a source coding, a sub-band coding (SBC), an adaptive predictive coding (APC), an adaptive transform coding (ATC), a residual excited linear predictive coding (RELP), and a hybrid coding including a multi-pulse linear predictive coding (MPLPC).

10. The method of claim 1, wherein the sequential steps from the extracting of the coder parameters to the recovering of the erased packet for the frame erasure recovery method are performed at an erased packet recovery unit of a microprocessor block storing the VCIIT.
